(19) United States
(12) Patent Application Publication
(10) Pub. No.: US 2014/0111605 A1
(43) Pub. Date: Apr. 24, 2014

(54) LOW-COMPLEXITY PANORAMIC IMAGE AND VIDEO STITCHING METHOD

(71) Applicant: NATIONAL CHUNG CHENG UNIVERSITY, Chia-Yi (TW)

(72) Inventors: Jiun-In GUO, CHIA-YI (TW); Jia-Hou CHANG, CHIA-YI (TW); Cheng-An CHIEN, CHIA-TI (TW)

(73) Assignee: NATIONAL CHUNG CHENG UNIVERSITY, CHIA-YI (TW)

(21) Appl. No.: 13/742,149

(22) Filed: Jan. 15, 2013

(30) Foreign Application Priority Data
Oct. 22, 2012 (TW) 101138976

(51) Int. Cl. H04N 5/232

(52) U.S. Cl. CPC H04N 5/23238
USPC 348/36

(57) ABSTRACT

A low-complexity panoramic image and video stitching method includes the steps of (1) providing a first image/video and a second image/video; (2) carrying out an image/video alignment to locate a plurality of common features from the first and second images/videos and to align the first and second images/videos pursuant to the common features; (3) carrying out an image/video projection and warping to make the first and second coordinates of the common features in the first and second images/videos correspond to each other and to stitch the first and second images/videos according to the mutually corresponsive first and second coordinates; (4) carrying out an image/video repairing and blending for compensating chromatic aberrations of at least one seam between the first and second images/videos; and outputting the stitched first and second images/videos.

### BACKGROUND OF THE INVENTION

1. Field of the Invention

The present invention relates generally to the panoramic image/video stitching, and more particularly, to a low-complexity panoramic image and video stitching method.

2. Description of the Related Art

The conventional image/video stitching usually contains steps of image alignment, image projection and warping, and image repairing and blending. The image alignment is to locate multiple feature points from a source image where the feature points are the positions corresponding to those of another source image to be stitched with the previous source image. Currently, David Lowe of University of British Columbia proposed a scale-invariant feature transform (SIFT) algorithm associated with the study of the image alignment. The algorithm is implemented for the source image by finding space-scale extremas via Gaussian blurring and marking the extrema as initial feature points; next, filtering out unapparent feature points subject to Laplacian operator and assigning a directional parameter to each feature point pursuant to distribution of the feature points in gradient orientation; and finally, generating a 128-dimension feature vector representing each feature point. Note that the feature point is based on the partial appearance of an object, irrelevant to image scale and rotation, and has better tolerance with illumination, noise, and few changes to view angle. Although SIFT is highly precise in finding the feature points, the algorithm is also highly complex.

Among the studies of image projection and warping, eight-parameter projective model mentioned in the literature proposed by Steven Mann discloses that the parameters can be converted to come up with preferable matrix transformation and projective outcome. However, the matrix transformation still needs consumption of much computational time.

As far as the image repairing and blending are concerned, Wu-Chih Hu et al. proposed an image blending scheme in 2007, which contains the steps of smoothing the colors of the overlaps of the left and right images, then figuring out the intensity of each point of the overlaps, and finally working out the pixel value eventually outputted via nonlinear weighted function. However, such image blending scheme still has the deficiency of complex computation, particularly involved with trigonometric function.

### SUMMARY OF THE INVENTION

The primary objective of the present invention is to provide a low-complexity panoramic image and video stitching method, which can carry out image/video stitching by means of the algorithm based on transformation of coordinate system to get a single panoramic image/video output; even if there is any rotation or scaling action between the source images//videos, a high-quality panoramic image/video can still be rendered

The secondary objective of the present invention is to provide a low-complexity panoramic image and video stitching method, which can reduce computational throughput by dynamic down-sampling of the source images/videos to quickly get a high-quality panoramic image/video.

The foregoing objectives of the present invention are attained by the method having the steps of providing a first image/video and a second image/video, the first image/video having a plurality of first features and first coordinates, the first features corresponding to the first coordinates one on one, the second image/video having a plurality of second features and second coordinates, the second features corresponding to the second coordinates one on one; carrying out an image/video alignment having sub-steps of locating a plurality of common features, each of which is what at least one of the first features is identical to at least one of the second features, and aligning the first and second images/videos pursuant to the common features; carrying out an image/video projection and warping having sub-steps of freezing the first coordinates and converting the second coordinates belonging to the common features to make the first and second coordinates of the common features correspond to each other, and then stitching the first and second images/videos according to the mutually corresponsive first and second coordinates; carrying out an image/video repairing and blending for compensating chromatic aberrations of at least one seam between the first and second images/videos; and outputting the stitched first and second images/videos.

### BRIEF DESCRIPTION OF THE DRAWINGS

FIG. 1 is a flow chart of a first preferred embodiment of the present invention.

FIG. 2 shows the first image.

FIG. 3 shows the second image.

FIG. 4 shows the stitched first and second images.

FIG. 5 is a flow chart of the step S20 in accordance with first preferred embodiment of the present invention.

FIG. 6 is a flow chart of the step S205 in accordance with the first preferred embodiment of the present invention.

FIG. 7 is a flow chart of the step S30 in accordance with the first preferred embodiment of the present invention.

FIG. 8 shows the stitched first and second images and a seam located between them.

FIG. 9 is a flow chart of the step S31 in accordance with first preferred embodiment of the present invention.

FIG. 10 is a flow chart of the step S4 in accordance with first preferred embodiment of the present invention.

FIG. 11 is a flow chart of a second preferred embodiment of the present invention.

FIGS. 12-15 show three respective images taken at multiple view angles and a panoramic image formed of the three images by stitching.

FIG. 16 is flow chart of stitching of five images taken at different view angles.

### DETAILED DESCRIPTION OF PREFERRED EMBODIMENTS

The present invention will become more fully understood by reference to four preferred embodiments given hereunder. However, it is to be understood that these embodiments are given by way of illustration only, thus are not limitative of the claim scope of the present invention.

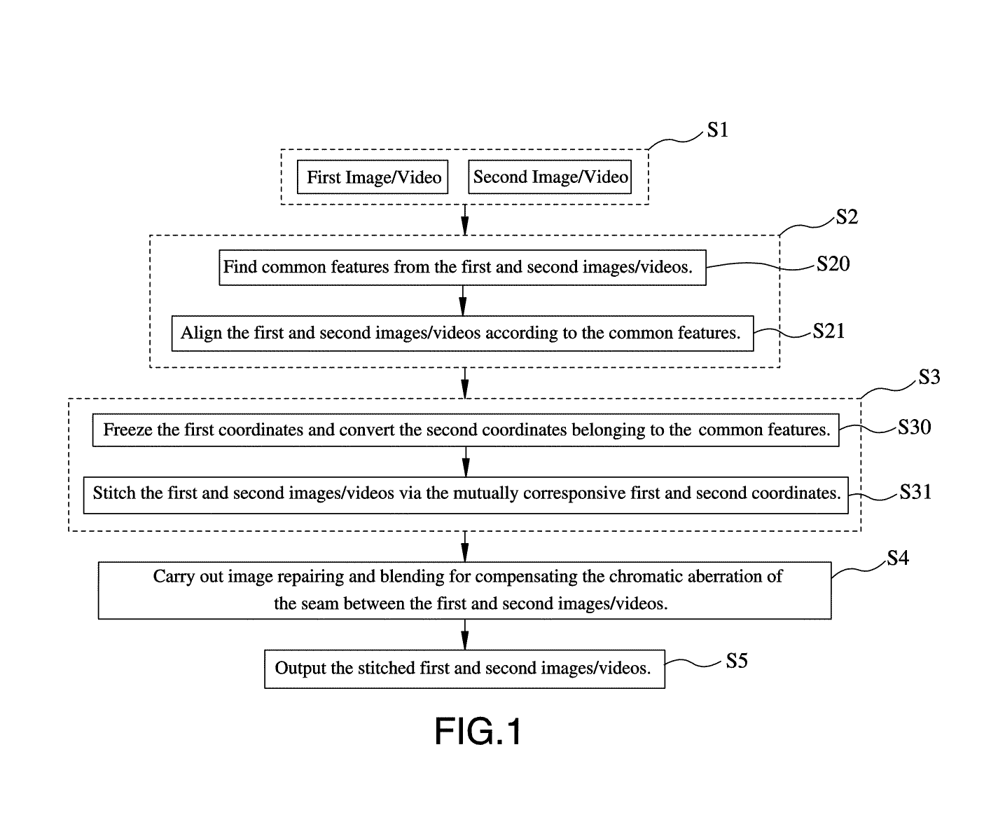

Referring to FIG. 1, a low-complexity panoramic image and video stitching method in accordance with a first preferred embodiment of the present invention includes the following steps.

S1: Provide a first image/video and a second image/video. The first image/video includes a plurality of first features and a plurality of first coordinates. The first features correspond to the first coordinates one on one. The second image/video includes a plurality of second features and a plurality of second coordinates. The second features correspond to the second coordinates one on one.

S2: Carry out an image/video alignment. The image/video alignment includes the following two sub-steps.
S20: Find a plurality of common features, each of which is what at least one of the first features is identical to at least one of the second features.
S21: Align the first and second images/videos according to the common features.

S3: Carry out an image/video projection and warping. The image/video projection and warping includes the following sub-steps.
S30: Freeze the first coordinates and convert the second coordinates belonging to the common features to make the first and second coordinates of the common features correspond to each other.
S31: Stitch the first and second images/videos via the mutually corresponsive first and second coordinates.

S4: Carry out an image/video repairing and blending for compensating chromatic aberration of a seam between the first and second images/videos.

S5: Output the first and second images/videos after the stitching.

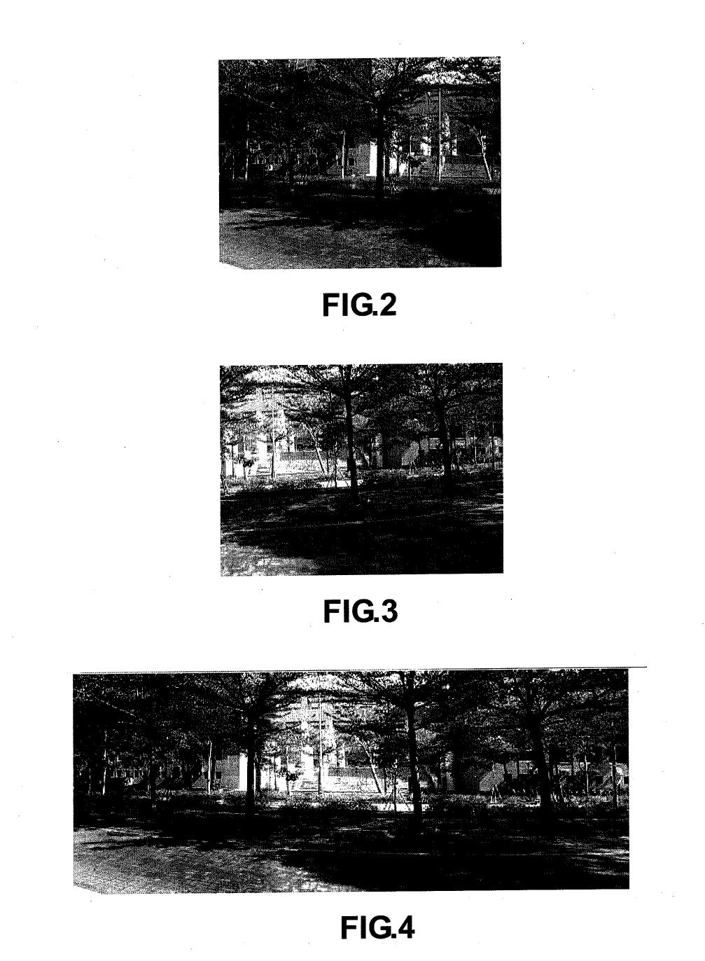

The first and second images/videos are acquired by a camera or a camcorder. In this embodiment, the first image/video indicates the left one shown in FIG. 2 and the second image/video indicates the right one shown in FIG. 3. Those first and second features are acquired by the following computation. First, find extremas from the first and second images/videos via Gaussian blurring and mark the extremas as initial feature points. Next, filter out less apparent initial feature points via Laplacian operator and then assign a directional parameter to each more apparent initial feature point pursuant to distribution of circumference of the feature points in gradient orientation. Finally, establish a 128-dimension feature vector corresponding to each more apparent initial feature points for denoting each first or second feature.

When the resolution of each of the first and second images/videos is XGA (1024×768 pixels), it indicates that the first or second image/video has 1024 dots along the horizontal axis and 768 dots along the vertical axis. The origin coordinate (0,0) of an image/video is usually located at the upper left corner of the image, so those dots cross each other to establish the coordinates of the first and second features.

In the sub-step S21, the aforesaid computation can align the first and second images/videos via the common features; namely, the locations of the common features of the first and second images/videos have been confirmed for accomplishment of the image alignment.

Next, in the sub-step S30, the first coordinates of the first image/vide are immobilized and only the coordinates of the second features belonging to the common features are converted in such a way that the converted second coordinates are identical to those of the first image. Because only the coordinates of the second image/video are converted, the computational time for the conversion of the first image/video can be saved. Besides, the second coordinates of the second images can also be immobilized and the first coordinates of the first image/video can also be converted.

Because the second coordinates after the conversion are identical to the first coordinates, the coordinates of the common features can enable the first and second images/videos to overlap each other to be stitched together. Next, in the step S4, the chromatic aberration (distortion) of the seam between the first and second images/videos is compensated to be eliminated. At last, in the step S5, the first and second images/videos after the stitching, namely a panoramic image/video, can be outputted. As shown in FIG. 4, note that if the panoramic image/video still contains chromatic aberration, it will be necessary to carry out the steps S3 and S4 again. In this way, after the steps S1-S5 are carried out, the method of the present invention can stitch the two images/videos by dynamic down-sampling and make the panoramic image/video after stitching have the same quality as the raw images/videos.

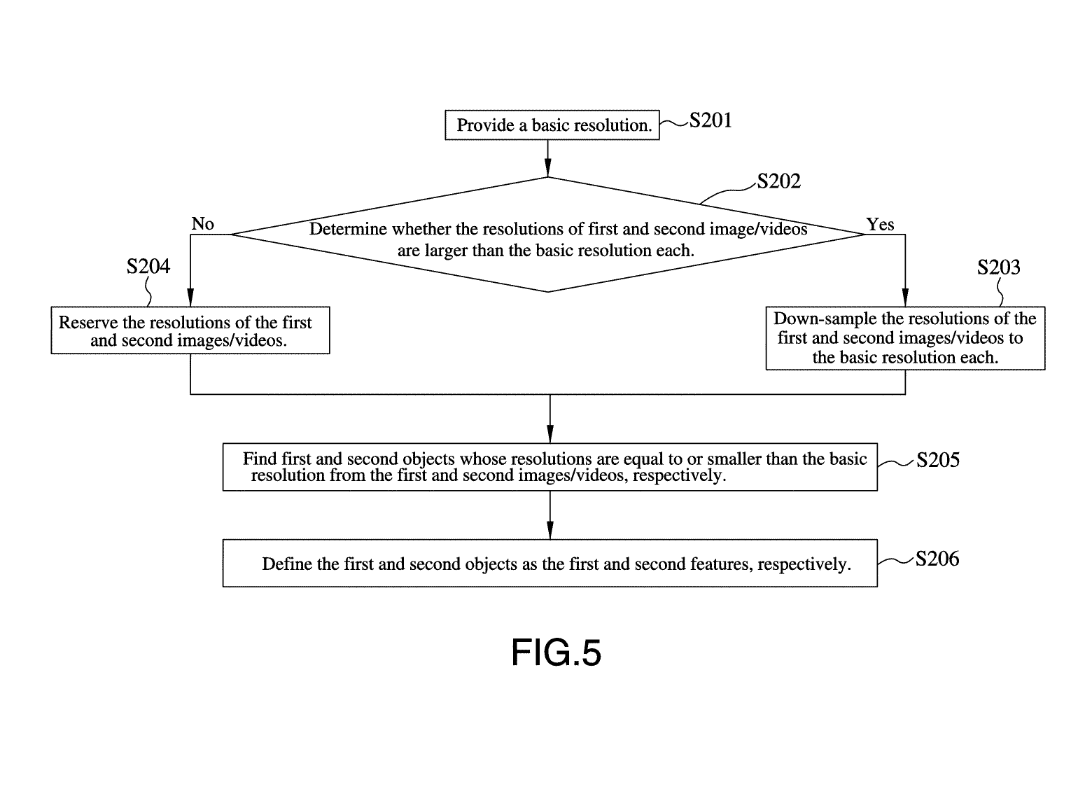

Referring to FIG. 5, the sub-step S20 includes the following two sub-sub-steps.

S201: Provide a basic resolution.

S202: Determine whether the resolutions of first and second image/videos are larger than the basic resolution each.

S203: If the resolutions of the first and second images/videos are larger than the basic resolution, down-sample the resolutions of the first and second images/videos to the basic resolution each.

S204: If the resolutions of the first and second images/videos are equal to or smaller than the basic resolution each, reserve the resolutions of the first and second images/videos.

S205: Find first and second objects whose resolutions are equal to or smaller than the basic resolution from the first and second images/videos, respectively.

S206: Define the first and second objects as the first and second features, respectively.

Referring to Table 1 shown below, if the first and second images/videos belong to the aforesaid XGA (1024×768 pixels), it will be necessary to down-sample the resolutions of the first and second images/videos for four levels each to lower their resolutions. In practice, the computation of the high-resolution image is apparently more complex than that of the low-resolution image. As far as the present invention is concerned, the features acquired via the low-resolution and high-resolution image computations respectively are indiscriminating. For this reason, the present invention indicates that the resolutions of the first and second images/vides should be identified, before the features are acquired via computation, to reduce extra computation.

TABLE 1

| Image Resolution | Down-Sample Ratio |
|---|---|
| CIF | 2 |
| VGA | 2 |
| SVGA | 3 |
| XGA | 4 |
| WXGA | 4 |
| HD1080 | 4 |

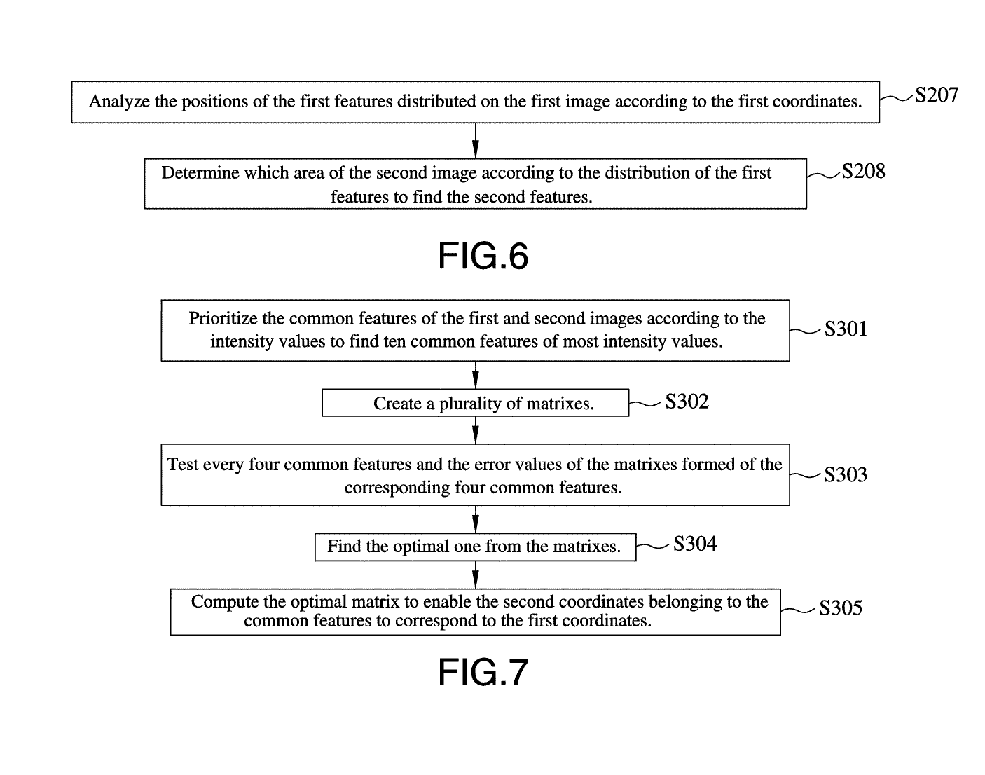

Referring to FIG. 6, the aforesaid sub-sub-step S205 preferably includes the following sub-sub-sub-steps.

S2051: Analyze the positions of the first features distributed on the first image according to the first coordinates.

S2052: Determine which area of the second image according to the distribution of the first features to find the second features. If the distribution of the first features is located on the right half of the first image, analyze the left half of the second image. If the distribution of the first features is located on the left half of the first image, analyze the right half of the second image.

The common features usually appear on the right side of the first image and the left side of the second image or on the left side of the first image and the right side of the second image, so the distribution of the first features on the first image can be analyzed to come up with whether the first features are distributed over the left or right half of the first image. When the first features are distributed over the left half of the first image, determine to analyze the right half of the second image. Similarly, when the first features are distributed over the right half of the first image, determined to analyze the left half of the second image. In this way, the computational efficiency can be enhanced.

Referring to FIG. 7, the sub-step S30 further includes the following five sub-sub-steps.

S301: Prioritize the common features of the first and second images according to the intensity values to find ten common features of most intensity values.

S302: Create a plurality of matrixes, each of which is formed of four of the ten common features.

S303: Test every four common features and the error values of the matrixes formed of the corresponding four common features.

S304: Find the optimal one from the matrixes. The optimal matrix includes the smallest error value among those of the other matrixes.

S305: Compute the optimal matrix to enable the second coordinates belonging to the common features to correspond to the first coordinates.

In the present invention, only ten intensest common features are selected for computation, so the less intense common features can be avoided to reduce the overall throughput. The matrixes are the permutation of the ten intensest common features and if every four of the matrixes constitute a matrix, there will be 210 matrixes in total. Test every four common features and the error values of the matrixes formed of the corresponding four common features to find the optimal matrix. The present invention is based on a test formula—Cost(H)=distAvg(Hp,q)—to test the common features and the matrixes. In this test formula, H denotes the tested matrix, p and q denote one set of corresponsive common feature points. The distance between the coordinate of p after matrix transformation and the coordinate of the corresponsive point q can serve as the error value of this set of features points, namely four common features. As the error value is smaller, the matrix is more applicable to this set of the feature points. If the accumulation of the error values of all sets of the feature points is divided by the number of all set of the feature points to get the smallest Cost(H), the matrix can make the coordinate after transformation most conformable to the corresponsive one and the matrix H is the selected optimal one.

Note that the computation is applied to the selected optimal matrix to inversely infer its inverse matrix. In light of the inverse matrix, the same coordinate system as that of the first image/video inversely infers the coordinate of the corresponsive second image/video. In the process of transformation of coordinate of positive matrix, the transformed images are not absolutely one on one and it may happen that multiple coordinates correspond to the same coordinate, so some coordinates do not have corresponsive ones to lose the information of the pixel thereof to result in image hole. The present invention infers the original coordinates from the corresponsive ones via the inverse matrix to get rid of the problem of the image hole. Besides, what the original coordinates reversely inferred contain are not integers but floating point values. If the influence resulting from the decimal fraction is not taken into account and the coordinates are rounded off, the pixels being the holes will each be filled in the adjacent pixels to though fill the holes but to have the same value in one of some areas to cause image blur and aliasing. For this reason, the present invention adopts the concepts of equinoctial point and quartile, amplifying the height and width of the raw image for quadruple and then apply 6-tap filter interpolation and linear interpolation to the values other than the raw pixel pursuant to the ambient pixels to generate an equinoctial point and a quartile, respectively. The equinoctial point is acquired by applying weighting adjustment to six raw pixels located on a parallel row or a vertical column and closest to the equinoctial pixel. The quartile is acquired by a mean of pixels adjacent thereto. In this way, more pixel information is available between the raw pixel and other pixels, so the positions of the floating point can be referenced.

Execution of the sub-sub-steps S301-S305 can convert one of the first and second images/videos to enable the coordinate system of the converted image/video to correspond to the other unconverted coordinate system in such a way that the first and second coordinates belonging to the common features can correspond to each other and then the sub-step D31 of stitching the first and second images/videos can proceed further.

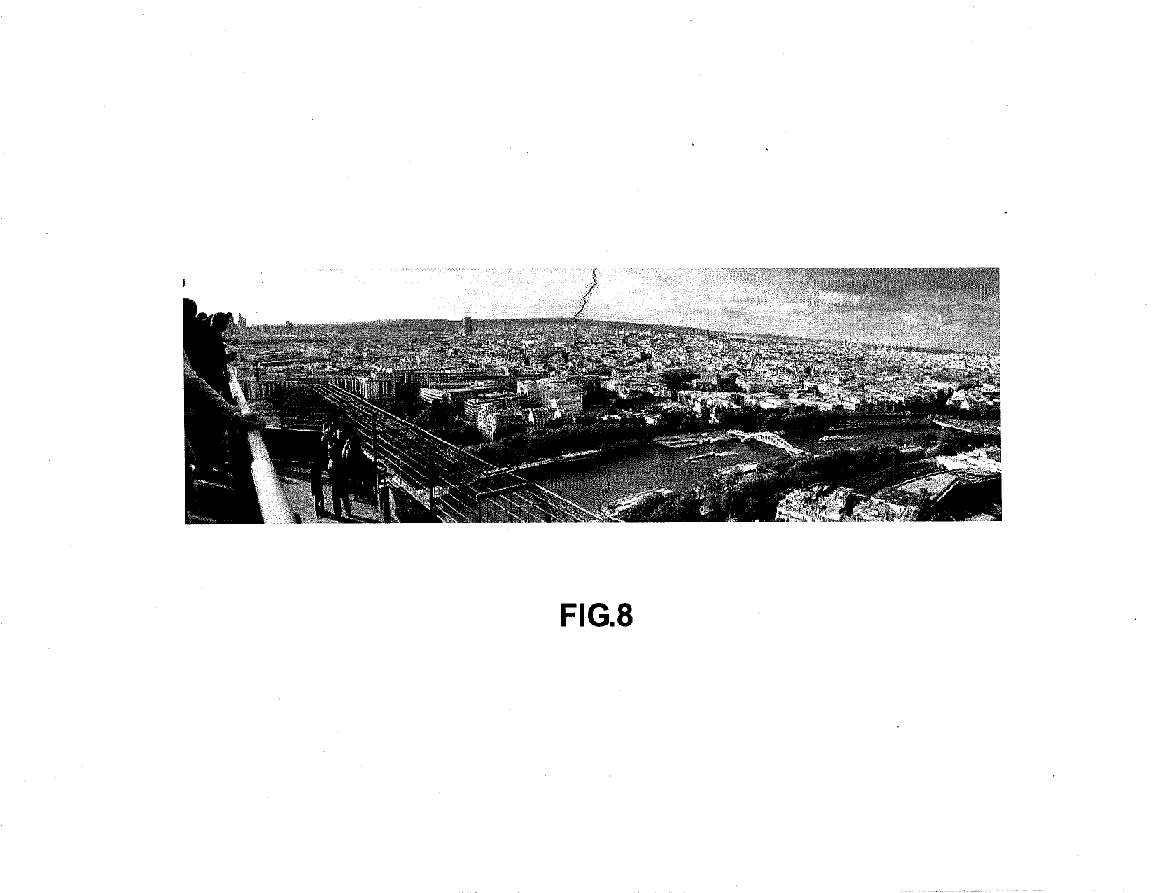

Referring to FIG. 8, an irregular joint line (seam) appears at the commissure between the first and second images/videos; the left half beside the joint line is the first image/video indicated in this embodiment and the right half beside the joint line is the second image/video indicated in this embodiment. In fact, if the joint line is fixed, while one of the first or second image/video is moved and passes through the joint line, the panoramic image/video becomes distorted. For this reason, the present invention proposes an optimal seam finding scheme for improvement of said drawback, applying dynamic programming to the distortion of overlapped blocks in the first and second images/videos to find and serve the joint line of the least difference as the seam of the image/video output.

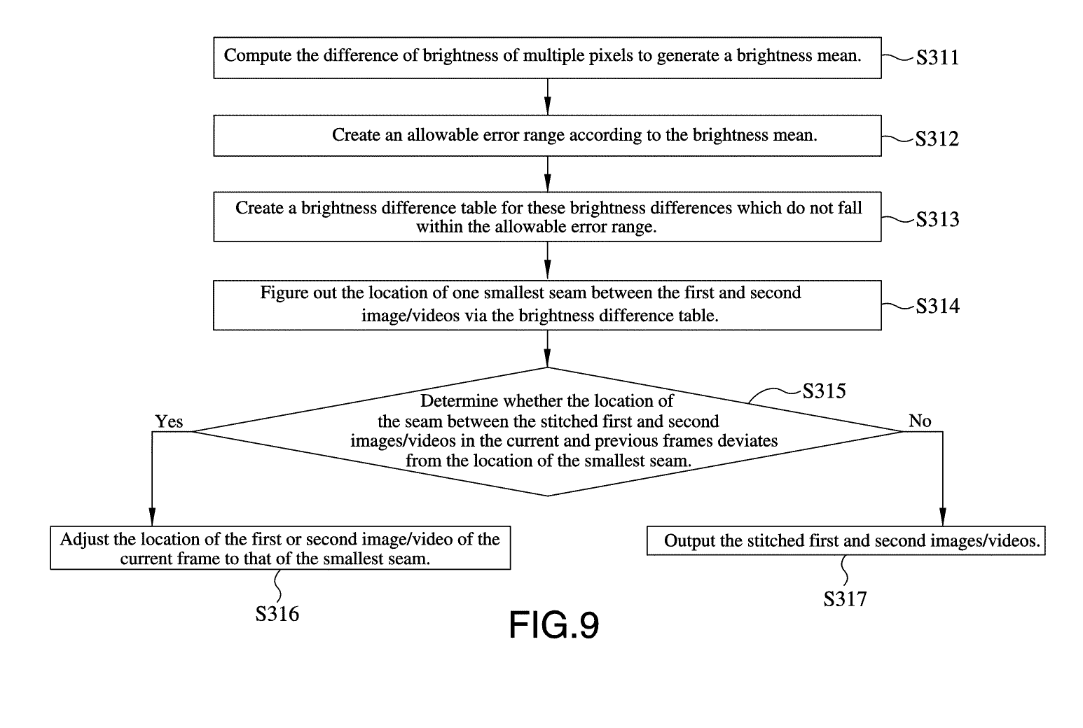

Referring to FIG. 9, the sub-step S31 further includes the following sub-sub-steps.

S311: Compute the difference of brightness of multiple pixels to generate a brightness mean where the pixels are located within the overlap of the first and second images/videos.

S312: Create an allowable error range according to the brightness mean.

S313: Create a brightness difference table for these brightness differences which do not fall within the allowable error range. The brightness difference table includes differences of the first and second images/videos in each of the pixels, differences of the first image/video of current and previous frames in each of the pixels, and differences of the second image/video of current and previous frames in each of the pixels.

S314: Figure out the location of one smallest seam between the first and second image/videos via the brightness difference table.

S315: Determine whether the location of the seam between the stitched first and second images/videos in the current and previous frames deviates from the location of the smallest seam. If the answer is positive, proceed to a sub-sub step S316 of adjusting the location of the first or second image/video of the current frame to that of the smallest seam to avoid unnatural vibration in the process of playback of a film. If the answer is negative, proceed to the sub-sub-step S317 of outputting the stitched first and second images/videos.

In practice, the pixels of the first and second images can become different subject to inconsistency of exposure of image input, so a range between two values higher and lower than the brightness mean is taken to denote the reasonable range of brightness error of each pixel of the overlap as indicated in the sub-sub-step S312. In the sub-sub-step S314, figure out the least difference in the image/video in view of the brightness difference table according to an equation: D (x, y)=A(x, y)+min{D(x, y−1), D(x, 1), D(x, y+1)} where A denotes pixel difference of coordinate (x, y) in the image/video and D denotes sum of the least difference from an uppermost side of the image/vide to the coordinate (x, y). Therefore, while figuring out the least difference, the present invention can synchronically record a corresponsive path of this frame and this path is the location of the smallest seam of this frame.

In light of the sub-sub-steps S311-S317, the present invention can redefine the optimal position of the joint line in each frame to eliminate the distortion resulting from moving object or other factor for the stitched image/video.

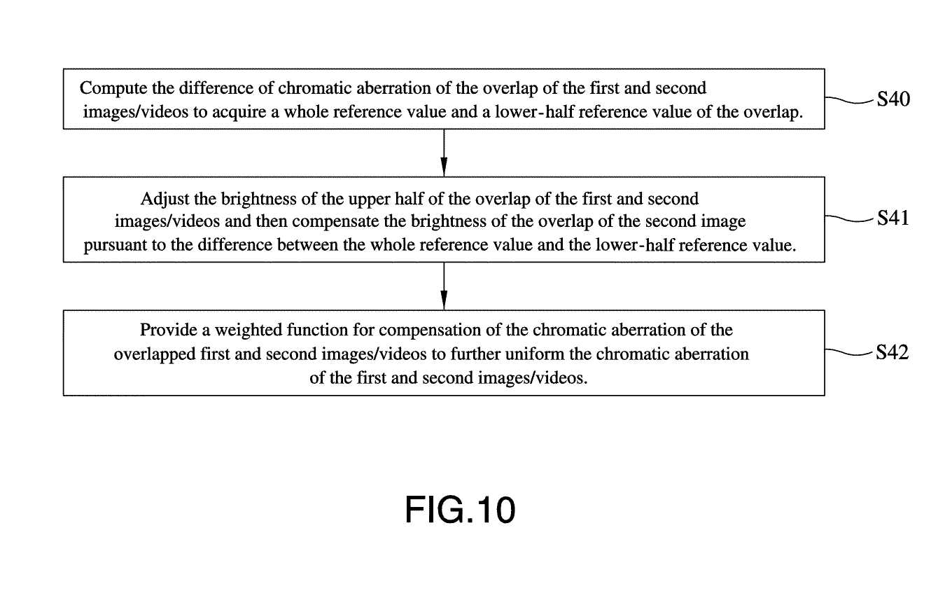

The panoramic image/video generated by execution of the step S3 may be partially deficient. Specifically, while it is intended to acquire an image/video via a camera lens for input, the location of the camera lens may lead to asynchronous parameters, like exposure and focus, in the process of taking a picture to further result in vignette and chromatic aberration in the acquired image/video. For this reason, the present invention proposes the step S4, i.e. the image/video repairing and blending, as shown in FIG. 10. The step S4 further includes the following sub-steps.

S40: Compute the difference of chromatic aberration of the overlap of the first and second images/videos to acquire a whole reference value and a lower-half reference value of the overlap. The whole and lower-half reference values are indicative of the difference between the first and second image/videos.

S41: Adjust the brightness of the upper half of the overlap of the first and second images/videos and then compensate the brightness of the overlap of the second image pursuant to the difference between the whole reference value and the lower-half reference value to make the upper-half image/video to approach the lower-half reference value from top to bottom.

S42: Provide a weighted function for compensation of the chromatic aberration of the overlapped first and second images/videos to further uniform the chromatic aberration of the first and second images/videos.

In practice, the image/video repairing and blending usually need to take brightness and color into account. The sensitivity of the human eyes to the brightness is higher than to the color, so the present invention applies compensation to the color of the image/video after the brightness is adjusted.

For example, when it is acquired that the whole reference value is 10 and the lower-half reference value is 5 after the computation in the sub-step S40, it is known that the whole overlapped image/video is brighter than the lower half of the image/video, so the brightness of the upper half of the image/video can be adjusted as indicated in the sub-step S41; namely, the brightness of the upper half of the image/video should be lowered to enable the brightness of the whole overlapped image/video is close to the lower-half reference value. The upper half of the image/video includes pixels arranged in multiple parallel rows, so when it is intended to adjust the brightness, start with the pixels in the upper row of the upper half of the image/video and end up with the pixels in the lower row of the same to enable the brightness of the upper half of the image/video to approach or equal the lower-half reference value. In this way, the brightness of the overlap of the first and second images/videos can be confirmed.

After the preliminary adjustment of the brightness of the image/video, to prevent the chromatic aberration of the objects in the stitched first and second image/video from overgreat difference, the present invention further has a weighted mean equation—Yᵣₑₛᵤₗₜ=(Y_{left}*ω+Y_{right*(}1−ω))—as indicated in the sub-step S42 for the image repairing and blending. After the calculation via the weighted mean equation, the chromatic aberration of the first and second images/videos can be effectively averaged.

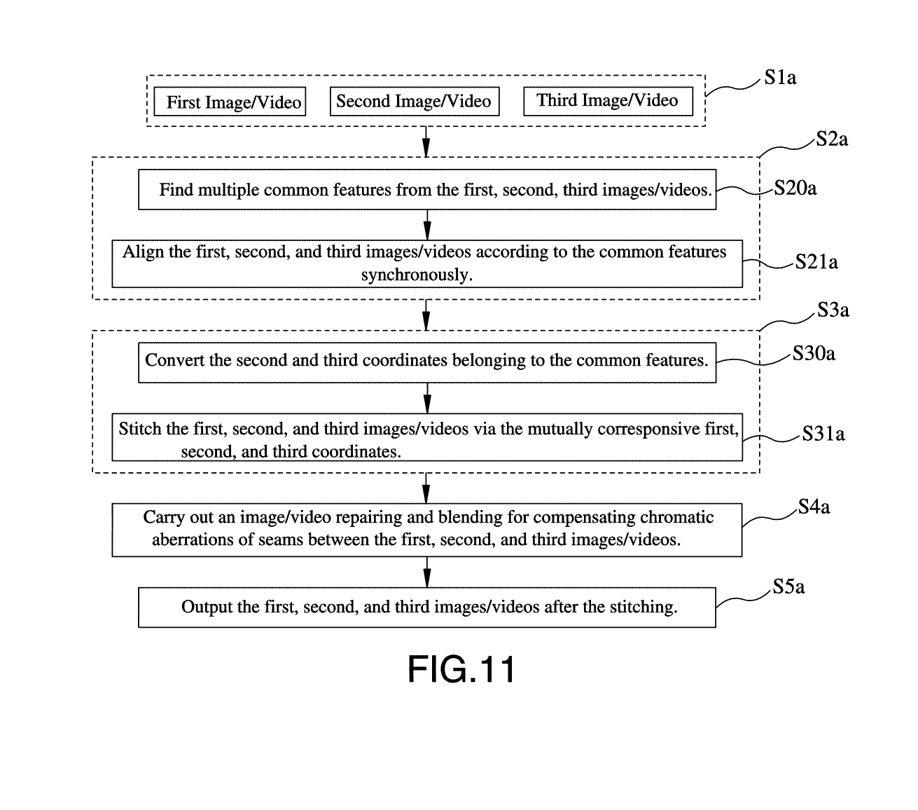

Referring to FIG. 11, a low-complexity panoramic image and video stitching method in accordance with a second preferred embodiment of the present invention can stitch images/videos taken at multiple view angles, including the following steps.

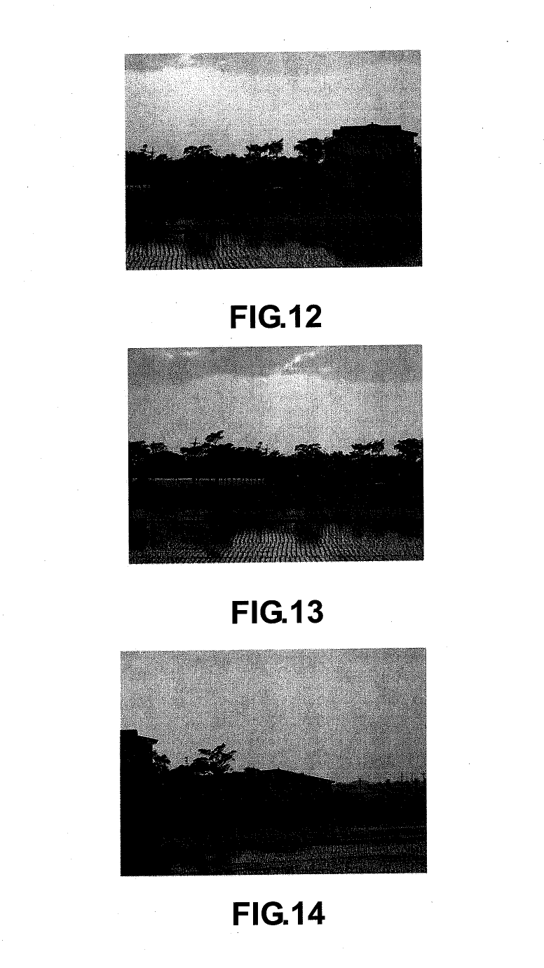

S1a: Provide a first image/video (FIG. 12), a second image/video (FIG. 13), and a third image/video (FIG. 14). The first image/video is taken at a middle view angle and includes multiple first features and multiple first coordinates; the first features correspond to the first coordinates one on one. The second image/video is taken at a left view angle and includes multiple second features and multiple second coordinates; the second features correspond to the second coordinates one on one. The third image/video is taken at a right view angle and includes multiple third features and multiple third coordinates; the third features correspond to the third coordinates one on one.

S2a: Carry out an image/video alignment.
S20a: Find multiple common features, each of which is what at least one of the second features is identical to at least one of the first features and what at least one of the third features is identical to at least one of the second features.
S21a: Align the first, second, and third images/videos according to the common features synchronously.

S3a: Carry out an image/video projection and warping.
S30a: Freeze the first coordinates and convert the second and third coordinates belonging to the common features to make the first, second, and third coordinates of the common features correspond to each other.
S31a: Stitch the first, second, and third images/videos via the mutually corresponsive first, second, and third coordinates.

S4a: Carry out an image/video repairing and blending for compensating chromatic aberrations of seams between the first, second, and third images/videos.

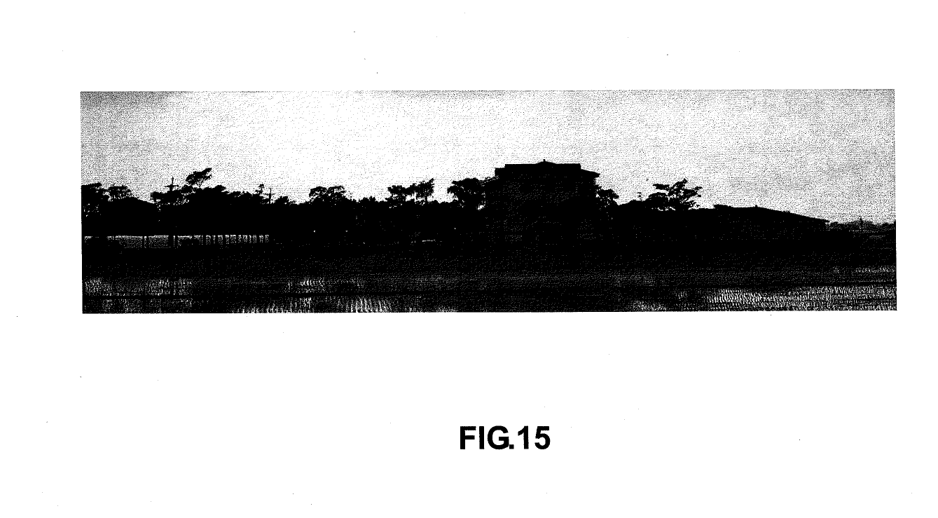

S5a: Output the first, second, and third images/videos after the stitching, as shown in FIG. 15.

In light of the steps S1a-S5a, when it is intended to stitch three or more images/videos, select the brightness and coordinate system of the middle view angle, serve it as a main view angle, and partition the image/video of the main view angle into two parts (left and right ones) for stitching with the images/videos of the adjacent view angles. After all of the images/videos of all view angles are stitched, they are stitched by translation to get a full multi-view panoramic image/video, as shown in FIG. 15.

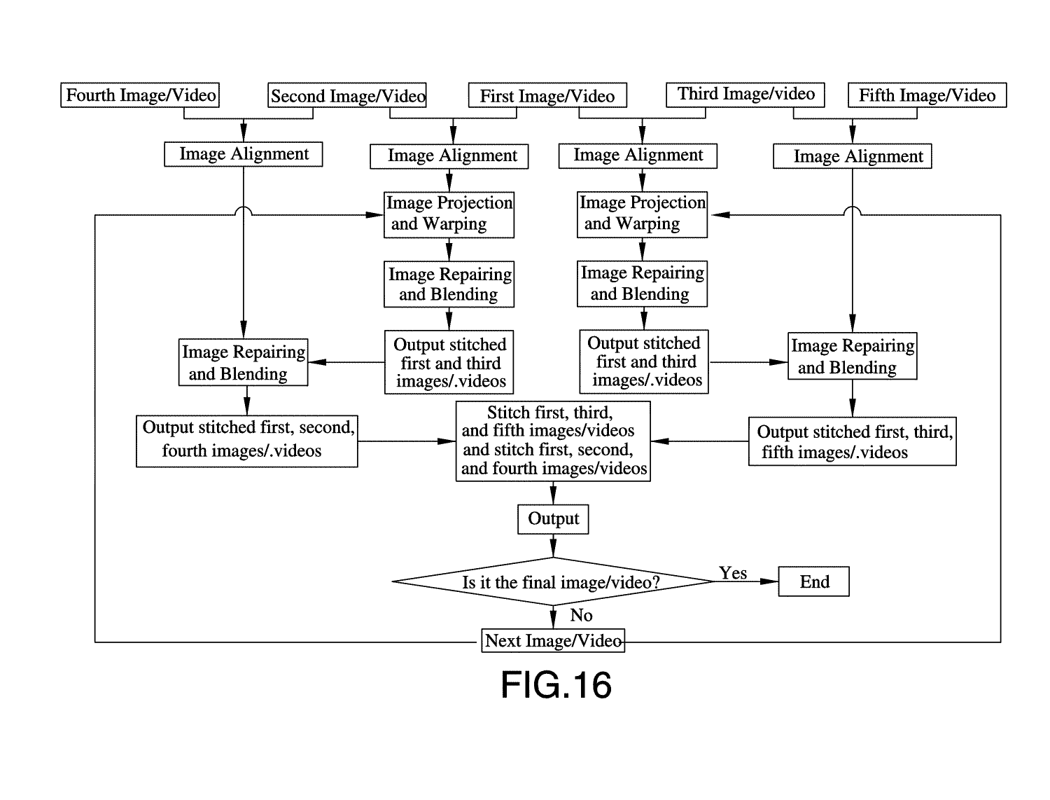

Note that the stitching indicated in the second embodiment proceeds as per the following sequence: define the middle view angle, partition the main view angle into two parts, stitch the images/videos of left and right view angles synchronously, and finally stitch the images/videos of two sides to get a multi-view panoramic image/video. Taking five view angles as an example, as shown in FIG. 16, the first image is the main view (middle view angle), the second and fourth images/videos are located at the left side of the main view, and the third and fifth images/videos are located at the right beside of the main view. The stitching sequence is: stitch the main view with the second and third images/videos simultaneously and then the third and fifth images/videos to get a multi-view panoramic image/video. Beside, the low-complexity panoramic image and video stitching method of the present invention is applicable to more view angles in addition to the aforesaid two, three, and five ones.

What is claimed is:

1. A low-complexity panoramic image and video stitching method comprising steps of:
providing a first image/video and a second image/video, the first image/video having a plurality of first features and a plurality of first coordinates, the first features corresponding to the first coordinates one on one, the second image/video having a plurality of second features and a plurality of second coordinates, the second features corresponding to the second coordinates one on one;
carrying out an image/video alignment, which has sub-steps of finding a plurality of common features, each of which is what at least one of the first features is identical to at least one of the second features, and aligning the first and second images/videos pursuant to the common features;
carrying out image/video projection and warping, which have sub-steps of freezing the first coordinates and converting the second coordinates belonging to the common features to make the first and second coordinates of the common features correspond to each other, and then stitching the first and second images/videos according to the mutually corresponsive first and second coordinates;
carrying out image/video repairing and blending for compensating chromatic aberration of at least one seam between the first and second images/videos; and
outputting the stitched first and second images/videos.

2. The method as defined in claim 1, wherein the sub-step of finding a plurality of common features further comprises sub-sub-steps of:
providing a basic resolution;
determining whether the resolutions of the first and second image/videos are larger than the basic resolution each; if the resolutions of the first and second images/videos are larger than the basic resolution each, down-sample the resolutions of the first and second images/videos to the basic resolution each; if the resolutions of the first and second images/videos are equal to or smaller than the basic resolution each, reserve the original resolutions of the first and second images/videos; and
finding first and second objects whose resolutions each are equal to or smaller than the basic resolution from the first and second images/videos respectively; and defining the first and second objects as the first and second features respectively.

3. The method as defined in claim 2, wherein the sub-sub-step of finding first and second objects further comprises sub-sub-sub-steps of:
analyzing the positions of the first objects distributed on the first image/video according to the first coordinates; and
determining which area of the second image/video is analyzed according to the distribution of the first objects to find the second objects; if the distribution of the first objects is located on the right half of the first image, analyze the left half of the second image; if the distribution of the first objects is located on the left half of the first image, analyze the right half of the second image.

4. The method as defined in claim 1, wherein the sub-steps of freezing the first coordinates and converting the second coordinates belonging to the common features further comprises sub-sub-steps of:
prioritizing the common features of the first and second images/videos according to the intensity values to find ten common features of most intensity values;
creating a plurality of matrixes, each of which is formed of four of the ten common features;
testing every four common features and the error values of the matrixes formed of the corresponsive four common features;
finding the optimal one from the matrixes, the optimal matrix having the smallest error value among those of the other matrixes; and
computing the optimal matrix to enable the second coordinates belonging to the common features to correspond to the first coordinates.

5. The method as defined in claim 1, wherein the sub-step of stitching the first and second images/videos comprises sub-sub-steps of
computing brightness difference of multiple pixels to generate a brightness mean where the pixels are located within the overlap of the first and second images/videos;
creating an allowable error range according to the brightness mean;
creating a brightness difference table for these brightness differences which do not fall within the allowable error range, the brightness difference table having differences of the first and second images/videos in each of the pixels, differences of the first image/video of current and previous frames in each of the pixels, and differences of the second image/video of the current and previous frames in each of the pixels;
figuring out the location of a smallest seam between the first and second image/videos via the brightness difference table; and
determining whether the location of the at least one seam between the stitched first and second images/videos in the current and previous frames deviates from the location of the smallest seam; if the answer is positive, adjust the location of the first or second image/video of the current frame to that of the smallest seam; if the answer is negative, output the stitched first and second images/videos.

6. The method as defined in claim 1, wherein the image/video repairing and blending comprises sub-steps of:
computing the difference of chromatic aberration of the overlap of the first and second images/videos to acquire a whole reference value and a lower-half reference value of the overlap, the whole and lower-half reference values are indicative of the difference between the first and second image/videos;
adjusting the brightness of the upper half of the overlap of the first and second images/videos and then compensating the brightness of the overlap of the second image/video pursuant to the difference between the whole reference value and the lower-half reference value to make the upper-half image/video to approach the lower-half reference value from top to bottom; and
providing a weighted function for compensation of the chromatic aberration of the overlapped first and second images/videos to further uniform the chromatic aberration of the first and second images/videos.

7. The method as defined in claim 1 further comprising steps of:
providing a third image/video having a plurality of third features and a plurality of third coordinates, the third features corresponding to the third coordinates one on one, the first image/video being taken at a middle view angle, the second image/video being taken at a left view angle relatively to the first image/video, the third image/video being taken at a right view angle relatively to the first image/video;
carrying out the image/video alignment to find the common features which are the third features identical to the first features and to align the third image/video with the first image/video synchronously according to the common features;
carrying out the image/video projection and warping to freeze the first coordinates and convert the third coordinates belonging to the common features, to make the third coordinates of the common features correspond to the first coordinates, and to stitch the first and third images/videos via the mutually corresponsive first and third coordinates; and
carrying out the image/video repairing and blending for compensating chromatic aberration of the at least one seam between the first and third images/videos.

8. A low-complexity panoramic image and video stitching method comprising steps of:
providing a first image/video, a second image/video, and a third image, the first image/video being taken at a middle view angle and having a plurality of first features and a plurality of first coordinates; the first features corresponding to the first coordinates one on one, the second image/video being taken at a left view angle and having a plurality of second features and a plurality of second coordinates, the second features corresponding to the second coordinates one on one, the third image/video being taken at a right view angle and having a plurality of third features and a plurality of third coordinates, the third features corresponding to the third coordinates one on one;
carrying out an image/video alignment comprising sub-steps of finding a plurality of common features, each of which is what at least one of the second features is identical to at least one of the first features and what at least one of the third feature is identical to at least one of the second features, and aligning the first, second, and third images/videos according to the common features synchronously;
carrying out an image/video projection and warping comprising sub-steps of freezing the first coordinates and converting the second and third coordinates belonging to the common features to make the first, second, and third coordinates of the common features correspond to each other, and then stitching the first, second, and third images/videos via the mutually corresponsive first, second, and third coordinates;
carrying out an image/video repairing and blending for compensating chromatic aberrations of seams between the first, second, and third images/videos; and
outputting the stitched first, second, and third images/videos.
